(19) United States
(12) Patent Application Publication
(10) Pub. No.: US 2026/0278983 A1
(43) Pub. Date: Sep. 17, 2026

(54) OBJECT DETECTION USING DIRECTION POLARITY INVARIANT CORNER PARAMETERIZATION

(71) Applicant: QUALCOMM Incorporated, San Diego, CA (US)

(72) Inventors: Karl Daniel Wester, Linköping (SE); Gaspar Kolumban, Linköping (SE); Gustav Lars Henrik Jagbrant, Linköping (SE); Gustav Nils Ture Persson, Ljungsbro (SE); Per Cronvall, Linköping (SE); Lars Erik Zacharias Nordstroem, Vikingstad (SE)

(21) Appl. No.: 19/075,845

(22) Filed: Mar. 11, 2025

(51) Int. Cl. G06V 10/25; G06T 7/13

(52) U.S. Cl. CPC G06V 10/25; G06T 7/13; G06T 2207/20164; G06V 2201/07

(57) ABSTRACT

A computing system may estimate for an object in an image, positions of one or more corners that correspond to one or more corner categories that are invariant to a direction polarity of the object. The computing device may determine an estimated reference point of a bounding box that bounds the object based on the positions of the one or more corners of the object and the one or more corner categories that correspond to the one or more corners. The computing device may generate the bounding box based on the estimated reference point of the bounding box and may output an indication of the bounding box.

### TECHNICAL FIELD

This disclosure relates to object recognition.

### BACKGROUND

Autonomous vehicles and semi-autonomous vehicles may use artificial intelligence (AI) and machine learning (ML) (e.g., neural networks) for performing various operations for operating, piloting, and navigating the vehicles. For example, neural networks may be used for object detection, lane and road boundary detection, safety analysis, drivable free-space analysis, control generation during vehicle maneuvers, and/or other operations. Neural network-powered autonomous and semi-autonomous vehicles should be able to respond properly to an incredibly diverse set of situations, including interactions with emergency vehicles, pedestrians, animals, and a virtually infinite number of other obstacles.

For autonomous vehicles to achieve autonomous driving levels 3-5 (e.g., conditional automation (Level 3), high automation (Level 4), and full automation (Level 5)) the autonomous vehicles should be capable of operating safely in all environments, and without the requirement for human intervention when potentially unsafe situations present themselves. An Advanced Driver Assistance System (ADAS) uses sensors and software to help vehicles avoid hazardous situations to ensure safety and reliability.

### SUMMARY

In general, this disclosure describes techniques for improving the estimation of three-dimensional poses of objects in captured images by using a specific output parametrization during inference time for neural networks used for automotive perception. This disclosure describes techniques for estimating the positions of one or more corners of an object and determining an estimated center point or other reference point of a bounding box for the object, which may provide a more accurate and robust estimate of the observable parameters of the object in a global coordinate space.

A computing system may train neural networks used for autonomous and semi-autonomous vehicles to perform object recognition tasks such as object tracking across consecutive frames, collision avoidance, and path planning. The computing system may train the neural networks to perform object recognition tasks. During inference time, a computing system that uses neural networks to perform object recognition tasks may capture images containing objects and may generate bounding boxes that bound the objects in the images. The computing system may input the captured images as well as indications of the bounding boxes for the objects into the neural networks, and the neural networks may perform object recognition tasks for objects in the inputted images using the bounding boxes for the objects.

However, when determining a bounding box for an object captured in an image, some of the parameters of the bounding box may be unobservable and/or may be difficult to accurately estimate. For example, when portions of an object is occluded in the image or when an object is not entirely inside the field of view of the image, it may be difficult for a computing system to accurately determine at least some of the dimensions of the vehicle, which may cause computing system to generate an erroneous bounding box for the object.

Further, certain approaches for generating a bounding box for an object may require the computing system to determine the direction polarity of the object, such as the positions of the front of the object and the rear of the object and/or the positions of the left side of the object and the right side of the object. In some situations, when portions of an object is occluded in the image or when an object is not entirely inside the field of view of the image, the computing system may be unable to accurately determine positions of the front of the object and the rear of the object, which may also cause the computing system to generate an erroneous bounding box for the object, which may not accurately define the spatial extent of the object within a scene captured in the image. For example, if the computing system is unable to accurately determine the positions of the front of the object and the rear of the object, the computing system may estimate the position of the front or the rear of the object to be an average between the directions of the front of the object and the rear of the object, which results in a poor estimate of the bounding box for the object.

To more accurately and robustly determine the poses of objects in captured images, including objects that are not fully captured in images, a computing system may select one or more visible corners of an object in an image that correspond to one or more corner categories that are invariant to the direction polarity of the object and may estimate three-dimensional positions of the one or more corners of the object in a global coordinate space of the scene captured in the image. The computing system may determine an estimated center point of a bounding box that bounds the object based on the three-dimensional positions of the one or more corners of the object, and may generate a bounding box for the object based on the estimated center point of the bounding box.

By estimating a center point of the bounding box based on corners of the object that correspond to one or more corner categories that are invariant to the direction polarity of the object and by generating the bounding box based on the estimated center point of the bounding box, the techniques of this disclosure may be able to generate the bounding box for the object in ways that are more accurate and robust compared to bounding box generation techniques that use an estimated center point of a bounding box for an object to estimate the positions of corners of the bounding box.

In some aspects, the techniques described herein relate to a method including: estimating, for an object in an image, positions of one or more corners that correspond to one or more corner categories that are invariant to a direction polarity of the object; determining an estimated reference point of a bounding box that bounds the object based on the positions of the one or more corners of the object and the one or more corner categories that correspond to the one or more corners; generating the bounding box based on the estimated reference point of the bounding box; and outputting an indication of the bounding box.

In some aspects, the techniques described herein relate to a computing system including: one or more memories; and processing circuitry implemented in circuitry, coupled to the one or more memories, and configured to: estimate, for an object in an image, positions of one or more corners that correspond to one or more corner categories that are invariant to a direction polarity of the object; determine an estimated reference point of a bounding box that bounds the object based on the positions of the one or more corners of the object and the one or more corner categories that correspond to the one or more corners; generate the bounding box based on the estimated reference point of the bounding box; and output an indication of the bounding box.

In some aspects, the techniques described herein relate to a computer-readable storage medium storing instructions thereon that when executed cause processing circuitry to: estimate, for an object in an image, positions of one or more corners that correspond to one or more corner categories that are invariant to a direction polarity of the object; determine an estimated reference point of a bounding box that bounds the object based on the positions of the one or more corners of the object and the one or more corner categories that correspond to the one or more corners; generate the bounding box based on the estimated reference point of the bounding box; and output an indication of the bounding box.

In some aspects, the techniques described herein relate to an apparatus including: means for estimating, for an object in an image, positions of one or more corners that correspond to one or more corner categories that are invariant to a direction polarity of the object; means for determining an estimated reference point of a bounding box that bounds the object based on the positions of the one or more corners of the object and the one or more corner categories that correspond to the one or more corners; means for generating the bounding box based on the estimated reference point of the bounding box; and means for outputting an indication of the bounding box.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example computing system.

FIG. 2A illustrates an example image captured by a camera, according to the techniques of this disclosure.

FIG. 2B is a conceptual diagram illustrating a bird's-eye view of a scene captured in the example image of FIG. 2A, according to the techniques of this disclosure.

FIG. 3 is a conceptual diagram showing an example technique for generating bounding boxes for objects captured in an image, according to the techniques of this disclosure.

FIG. 4 is a flowchart showing an example method of operation according to the techniques of this disclosure.

### DETAILED DESCRIPTION

In general, this disclosure describes techniques for more accurately determining the pose of objects in captured images for use during training and/or inference time of neural networks used for automotive perception. Instead of techniques that use an estimated center point of a bounding box for an object to estimate the positions of corners of the object or techniques that may require determining the absolute direction of the object, this disclosure describes techniques for estimating the positions of one or more corners of an object that correspond to corner categories that are invariant to the direction polarity of the object and determining an estimated reference point, such as an estimated center point, of a bounding box for the object based on the estimated positions of the one or more corners of the object, which may provide a more accurate estimate of the position of the object in a global coordinate space.

Bounding boxes that bound objects captured in an image, such as a picture or a frame of a video captured by a camera, may define the spatial extent of the objects within a scene captured in the image. The coordinates of a bounding box that bounds an object in an image may specify where the object is in the image and the approximate dimensions of the object the image. Three-dimensional bounding boxes may represent objects bounded by the bounding boxes in a real-world coordinate space of the scene captured in the image and may specify the poses of the objects in such a three-dimensional space, such as the position and orientation (e.g., roll, pitch, and/or yaw) of the objects in in the real-world coordinate space, which are often described in terms of translation (location) and rotation (angle) relative to the real-world coordinate space. As such, by generating a bounding box for an object that defines the spatial extent of the object within the coordinate space of the scene, a computing system may determine the pose of the object in the scene captured in the image.

In automotive perception, bounding boxes may be used to identify and localize objects (e.g., vehicles, pedestrians, cyclists, etc.) within an image, and may be used in place of the objects bound by the bounding boxes to perform tasks such as object tracking across consecutive frames, collision avoidance, and path planning. As such, machine learning systems may train a machine learning model, such as an automotive perception model to perform such tasks using bounding boxes that bound objects within images to perform tasks such as object tracking, collision avoidance, path planning, and the like.

A computing system may determine the pose of an object captured in an image by generating a bounding box that bounds the object, such that the pose of the bounding box corresponds to the pose of the object bound by the bounding box. One approach to generating a bounding box that bounds an object captured in an image include estimating a center point of the bounding box in a three-dimensional coordinate space associated with the scene captured in the image, determining an orientation (e.g., roll, pitch, and yaw) of the bounding box in the three-dimensional coordinate space, and determining the dimensions (e.g., length, width, and height) of the bounding box in the three-dimensional coordinate space. The computing system may estimate the positions of the corners of the bounding box based on the center point, dimensions, and orientation of the bounding box and may generate the bounding box based on such parameters.

A computing system may generate a bounding box for an object based on the portion of the object captured in the image. In automotive perception where objects are vehicles, a camera may generally capture perspective views of vehicles in the image, and the computing system may estimate parameters such as the center point, dimensions, orientation, and positions of the corners of the bounding box to generate the bounding box for the object.

However, when estimating such parameters for generating a bounding box for an object captured in an image, some of the parameters may be unobservable and/or may be difficult to accurately estimate. For example, when portions of an object is occluded in the image or when an object is not entirely inside the field of view of the image, it may be difficult for a computing system to accurately determine at least some of the dimensions of the vehicle, which may cause computing system to generate an erroneous bounding box for the object.

Further, certain approaches for generating a bounding box for an object may require the computing system to determine the direction polarity of the object, such as the positions of the front of the object and the rear of the object. In some situations, when portions of an object is occluded in the image or when an object is not entirely inside the field of view of the image, the computing system may be unable to accurately determine positions of the front of the object and the rear of the object, which may also cause the computing system to generate an erroneous bounding box for the object, which may not accurately define the spatial extent of the object within a scene captured in the image.

In accordance with aspects of this disclosure, a computing system may estimate the positions of one or more corners of an object in an image. The one or more corners may be a subset of all of the corners of the object, such as one or more corners that are visible within the image, and computing system may estimate the three-dimensional positions of the one or more corners in a three-dimensional coordinate space of the scene captured in the image.

The one or more corners may correspond to one or more corner categories, where the one or more corner categories are independent from the direction polarity of the object. That is, the one or more corner categories do not correspond to whether the one or more corners are at the front or the rear of the object. In some examples, the one or more corner categories may include a short-side left corner, a short-side right corner, a long-side left corner, and a long-side right corner. In some other examples, such as for objects classes where the longitudinal extent of the object may be smaller than the lateral extent of the object, the one or more corner categories may include a longitudinal-side left corner, a longitudinal-side right corner, a lateral-side left corner, and a lateral-side right corner.

In some examples, the computing system may estimate a polarity invariant orientation of the object, such as by determining a short side of the object and/or a long side of the object, and may determine the one or more corner categories that correspond to the one or more corners of the object based on the polarity invariant orientation of the object. For example, the computing system may determine that a corner is at a short side of the object, and may determine that a short-side left corner category or a short-side right corner category corresponds to the corner based on whether the corner is a left-most corner on the short side of the object in the image or a right-most corner on the short side of the object. In another example, the computing system may determine that a corner is at a long side of the object, and may determine that a long-side left corner category or a long-side right corner category corresponds to the corner based on whether the corner is a left-most corner on the long side of the object in the image or a right-most corner on the long side of the object.

The computing system may determine an estimated center point for a bounding box that bounds the object based on the positions of the one or more corners of the object and the one or more corner categories that correspond to the one or more corners. In some examples, the computing system may determine an estimated center point for a bounding box to be offset from the position of a corner of the object by half of the estimated length of the object and by half of the estimated width of the object. The computing system may determine, based on the corner category that corresponds to a corner, how to traverse a local coordinate space of the object by half of the estimated length of the object and by half of the estimated width of the object from the position of the corner, to determine the estimated center point for the bounding box.

The computing system may generate the bounding box based on the estimated center point for the bounding box. For example, the computing system may construct a bounding box having the estimated center point and dimensions (e.g., length, width, and height) that correspond to estimated dimensions of the object. In some examples, the computing system may employ a separate classifier to determine a direction polarity of the object and may generate the bounding box based on the direction polarity of the object.

The computing system may output an indication of the generated bounding box for an object. The indication of a bounding box may include indications of the position, dimensions, orientation, and the like of the bounding box. In some examples, a machine learning system may train an automotive perception model to perform object recognition using a training dataset that includes the indication of the bounding box. In some examples, an automotive perception model may, during inference time, generate bounding boxes for objects according to the disclosed techniques to perform object recognition tasks such as object tracking, collision avoidance, and path planning.

The techniques of this disclosure provides certain technical advantages. The techniques of this disclosure may enable more accurate determination of bounding boxes for objects based on images of the objects in cases where portions of the objects are not captured in images. By determining an estimated center point of a bounding box for an object in an image based on corners of the object that are visible in the image and by categorizing the visible corners of the image as corner categories that are invariant to the direction polarity of the object, the techniques of this disclosure, the techniques of this disclosure may be able to more accurately and robustly generate bounding boxes for objects compared with techniques that may determine positions of the corners of a bounding box based on an estimated center point for the bounding box.

As the determined bounding boxes may be used to train automotive perception models to perform tasks such as object tracking, collision avoidance, and path planning, and may be used by automotive perception models at inference time to perform those tasks, being able to more accurately and robustly determine bounding boxes for objects based on images of the objects in cases where portions of the objects are not captured in images may improve the performance of automotive perception models that uses the determined bounding boxes at training time and/or at inference time. The techniques of this disclosure may therefore providing improvements in the technical field of assisted and/or autonomous driving.

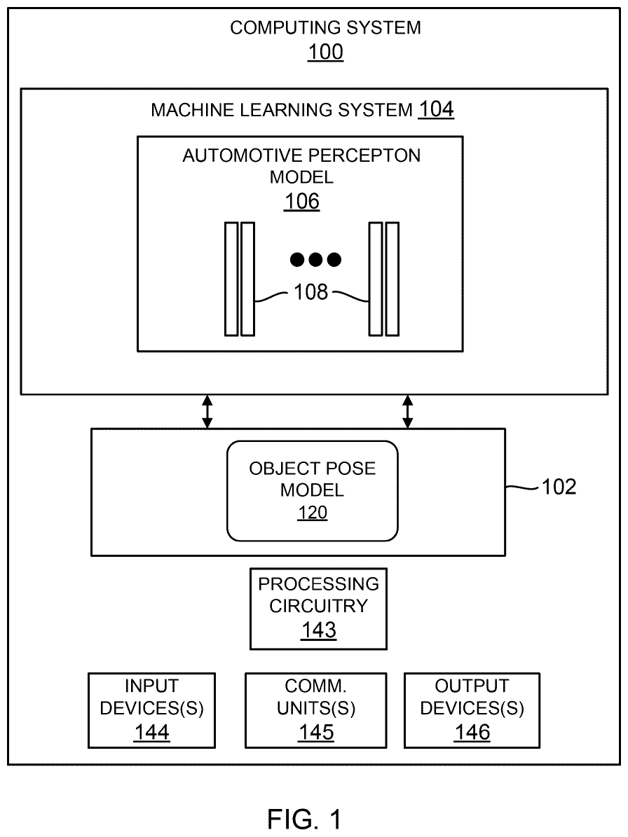

FIG. 1 is a block diagram illustrating an example computing system 100. As shown, computing system 100 comprises processing circuitry 143 and memory 102 for executing a machine learning system 104. In an aspect, machine learning system 104 may execute to train one or more neural networks, such as, such as automotive perception model 106 (also referred to herein as, “machine learning model 106”) comprising layers 108. The machine learning model 106 may comprise any of various types of neural networks, such as, but not limited to, recursive neural networks (RNNs), convolutional neural networks (CNNs), and deep neural networks (DNNs). In the example of FIG. 1, memory 102 may include object pose model 120.

Computing system 100 may also be implemented as any suitable external computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 100 may represent a cloud computing system, server farm, and/or server cluster (or portion thereof) that provides services to client devices and other devices or systems. In other examples, computing system 100 may represent or be implemented through one or more virtualized compute instances (e.g., virtual machines, containers, etc.) of a data center, cloud computing system, server farm, and/or server cluster. In some examples, computing system 100 may be part of a vehicle that includes an advanced driver assistance system (ADAS), and processing circuitry 143 and memory 102 may execute machine learning model 106 to perform automotive perception tasks.

The techniques described in this disclosure may be implemented, at least in part, in hardware, software, firmware or any combination thereof. For example, various aspects of the described techniques may be implemented within processing circuitry 143 of computing system 100, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 100 comprises any suitable computing system having one or more computing devices, such as desktop computers, laptop computers, gaming consoles, smart televisions, handheld devices, tablets, mobile telephones, smartphones, etc. In some examples, at least a portion of computing system 100 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 102 may comprise one or more storage devices. One or more components of computing system 100 (e.g., processing circuitry 143, memory 102, machine learning model 106, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 143 of computing system 100 may implement functionality and/or execute instructions associated with computing system 100. Examples of processing circuitry 143 include microprocessors, application processors, display controllers, auxiliary processors, one or more sensor hubs, and any other hardware configured to function as a processor, a processing unit, or a processing device. Computing system 100 may use processing circuitry 143 to perform operations in accordance with one or more aspects of the present disclosure using software, hardware, firmware, or a mixture of hardware, software, and firmware residing in and/or executing at computing system 100. The one or more storage devices of memory 102 may be distributed among multiple devices.

Memory 102 may store information for processing during operation of computing system 100. In some examples, memory 102 comprises temporary memories, meaning that a primary purpose of the one or more storage devices of memory 102 is not long-term storage. Memory 102 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 102, in some examples, may also include one or more computer-readable storage media. Memory 102 may be configured to store larger amounts of information than volatile memory. Memory 102 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 102 may store program instructions and/or data associated with one or more of the modules described in accordance with one or more aspects of this disclosure.

Processing circuitry 143 and memory 102 may provide an operating environment or platform for one or more modules or units (e.g., machine learning model 106), which may be implemented as software, but may in some examples include any combination of hardware, firmware, and software. Processing circuitry 143 may execute instructions and the one or more storage devices, e.g., memory 102, may store instructions and/or data of one or more modules. The combination of processing circuitry 143 and memory 102 may retrieve, store, and/or execute the instructions and/or data of one or more applications, modules, or software. The processing circuitry 143 and/or memory 102 may also be operably coupled to one or more other software and/or hardware components, including, but not limited to, one or more of the components illustrated in FIG. 1.

Processing circuitry 143 may execute machine learning system 104 and object pose model 120 using virtualization modules, such as a virtual machine or container executing on underlying hardware. One or more of such modules may execute as one or more services of an operating system or computing platform. Aspects of machine learning system 104 and object pose model 120 may execute as one or more executable programs at an application layer of a computing platform.

One or more input devices 144 of computing system 100 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 146 may generate, transmit, or process output. Examples of output are visual, video, tactile, and/or audio output. Output devices 146 may include a display, sound card, video graphics adapter card, speaker, presence-sensitive screen, one or more USB interfaces, video and/or audio output interfaces, or any other type of device capable of generating tactile, audio, video, or other output. Output devices 146 may include a display device, which may function as an output device using technologies including liquid crystal displays (LCD), quantum dot display, dot matrix displays, light emitting diode (LED) displays, organic light-emitting diode (OLED) displays, e-ink, or monochrome, color, or any other type of display capable of generating tactile, audio, and/or visual output. In some examples, computing system 100 may include a presence-sensitive display that may serve as a user interface device that operates both as one or more input devices 144 and one or more output devices 146.

One or more communication units 145 of computing system 100 may communicate with devices external to computing system 100 (or among separate computing devices of computing system 100) by transmitting and/or receiving data, and may operate, in some respects, as both an input device and an output device. In some examples, communication units 145 may communicate with other devices over a network. In other examples, communication units 145 may send and/or receive radio signals on a radio network such as a cellular radio network. Examples of communication units 145 include a network interface card (e.g., such as an Ethernet card), an optical transceiver, a radio frequency transceiver, a GPS receiver, or any other type of device that can send and/or receive information. Other examples of communication units 145 may include Bluetooth®, GPS, 3G, 4G, and Wi-Fi® radios found in mobile devices as well as Universal Serial Bus (USB) controllers and the like.

In accordance with aspects of this disclosure, computing system 100 may include object pose model 120 that processing circuitry 143 may execute to determine, for an image captured by a camera (e.g., one or more input devices 144) of a scene containing an object, a bounding box that bounds the object in the image. Processing circuitry 143 may use the generated bounding box for the object as input into machine learning model 106 during inference time to perform tasks such as object tracking, collision avoidance, and path planning.

A bounding box for an object in an image may define the spatial extent of the object within a scene captured in the image, and the coordinates of the bounding box that bounds an object in the image may specify where the object is in the image and the approximate dimensions of the object the image. The bounding box may be a three-dimensional bounding box that represents the bounded object in the three-dimensional global coordinate space of the scene captured in the image and may specify the pose of the object in such a three-dimensional space, such as the position and orientation (e.g., roll, pitch, and/or yaw) of the object.

To determine a bounding box for an object in an image, processing circuitry 143 may execute object pose model 120 to estimate the positions of one or more corners of an object in an image. The one or more corners may be a subset of all of the corners of the object, such as one or more corners that are visible within the image, and computing system may estimate the three-dimensional positions of the one or more corners in a three-dimensional coordinate space of the scene captured in the image.

Processing circuitry 143 may execute object pose model 120 to determine one or more corner categories that correspond to the one or more corners of the object, where the one or more corner categories are independent from the direction polarity of the object. That is, the one or more corner categories are independent of whether the one or more corners are at the front or the rear of the object. The one or more corner categories include a short-side left corner, a short-side right corner, a long-side left corner, and a long-side right corner.

In some examples, object pose model 120 may estimate a polarity invariant orientation of the object, such as by determining a short side of the object and/or a long side of the object, and may determine the one or more corner categories that correspond to the one or more corners of the object based on the polarity invariant orientation of the object. For example, the computing system may determine that a corner is at a short side of the object, and may determine that a short-side left corner category or a short-side right corner category corresponds to the corner based on whether the corner is a left-most corner on the short side of the object in the image or a right-most corner on the short side of the object. In another example, object pose model 120 may determine that a corner is at a long side of the object, and may determine that a long-side left corner category or a long-side right corner category corresponds to the corner based on whether the corner is a left-most corner on the long side of the object in the image or a right-most corner on the long side of the object.

Processing circuitry 143 may execute object pose model 120 to determine an estimated center point for a bounding box that bounds the object based on the positions of the one or more corners of the object and the one or more corner categories that correspond to the one or more corners. In some examples, object pose model 120 may determine an estimated center point for a bounding box to be offset from the position of a corner of the object by half of the estimated length of the object and by half of the estimated width of the object. Object pose model 120 may determine, based on the corner category that corresponds to a corner, how to traverse a local coordinate space of the object by half of the estimated length of the object and by half of the estimated width of the object from the position of the corner, to determine the estimated center point for the bounding box.

Processing circuitry 143 may execute object pose model 120 to generate the bounding box based on the estimated center point for the bounding box. For example, object pose model 120 may construct a bounding box having the estimated center point and dimensions (e.g., length, width, and height) that correspond to estimated dimensions of the object. In some examples, object pose model 120 may employ a separate classifier to determine a direction polarity of the object and may generate the bounding box based on the direction polarity of the object.

Object pose model 120 may output an indication of the generated bounding box for an object. The indication of a bounding box may include indications of the position, dimensions, orientation, and the like of the bounding box. In some examples, a machine learning system, such as object pose model 120 may train machine learning model 106, which may be an automotive perception model, to perform object recognition using a training dataset that includes the indication of the bounding box. In some examples, an automotive perception model such as machine learning model 106 may, during inference time, generate bounding boxes for objects according to the disclosed techniques to perform object recognition tasks such as object tracking, collision avoidance, and path planning.

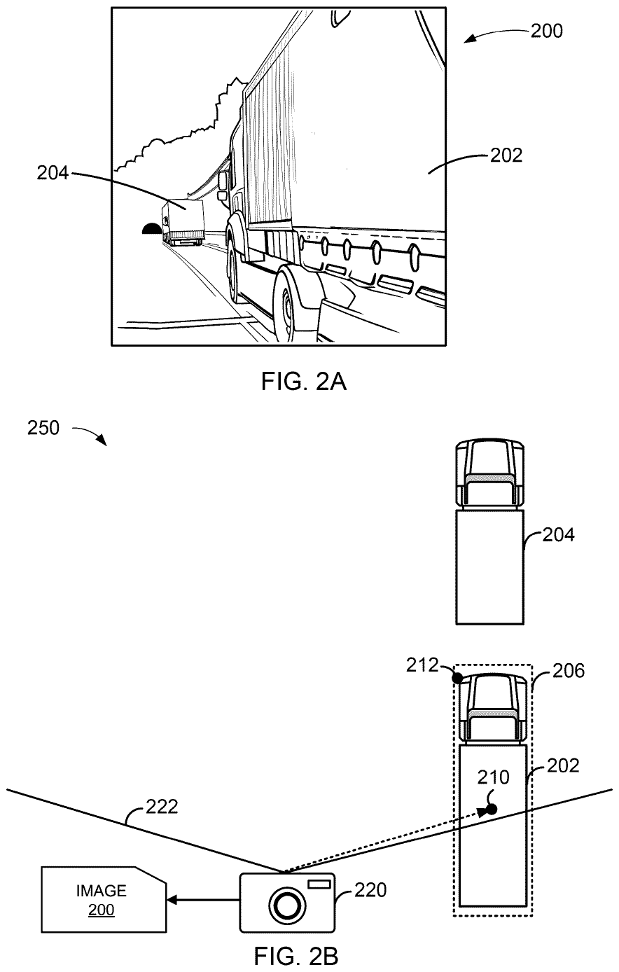

FIG. 2A illustrates an example image captured by a camera, according to the techniques of this disclosure. FIG. 2A is described with respect to computing system 100 of FIG. 1.

As shown in FIG. 2A, image 200 may be a frame of a video or any other suitable image captured by a camera. In some examples, the techniques of this disclosure may be used to train an automotive perception model to recognize objects in image 200 or used at inference time by an automotive perception model to recognize objects in image 200. In the example of FIG. 2A, image 200 includes objects 202 and 204.

A camera may capture a scene in a perspective view, as shown in image 200, and an automotive perception model may use what is captured in image 200 to recognize objects in the scene captured in image 200. For example, an automotive perception model may attempt to estimate the size, position, and/or pose of objects in the scene captured in image 200 to generate bounding boxes that bound the objects in image 200. However, while the entirety of object 204 is in image 200, only a portion (i.e., less than the entirety) of object 202 is in image 200. As such, it may be challenging for an automotive perception model to accurately generate a bounding box that bounds object 202.

FIG. 2B is a conceptual diagram illustrating a bird's-eye view of the scene 250 captured in image 200 of FIG. 2A, according to the techniques of this disclosure. FIG. 2B is described with respect to computing system 100 of FIG. 1. As can be seen in the bird's-eye view of scene 250 captured in image 200 of FIG. 2A, the entirety of object 204 is within camera 220's field of view 222, but less than the entirety of object 202 is within camera 220's field of view 222. That is, a portion of object 202 is outside of camera 220's field of view 222 and not captured in image 200.

In accordance with aspects of this disclosure, processing circuitry 143 may execute object pose model 120 to estimate, for object 202 in image 200, positions of one or more corners of the object. As can be seen, object 202 may have corner 212 that is visible in image 200. Object pose model 120 may select the visible corner 212 of object 202 and may estimate the position of corner 212 in a global coordinate space associated with the scene captured by image 200.

Object pose model 120 may determine one or more corner categories that are invariant to a direction polarity of the object that correspond to the one or more corners. While object 202 may have a direction polarity, such as by having a defined front and rear, object pose model 120 may not have to determine, for a corner of object 202, whether the corner of object 202 is at the front of object 202 or at the rear of object 202. Instead, object pose model 120 may determine a long side of object 202 and/or a short side of object 202 based on image 200. Object pose model 120 may determine whether corner 212 is a corner at the short side or the long side of object 202, and whether the corner is a left corner or right corner at the short side or the long side of object 202. Object pose model may therefore determine that corner 212 corresponds to one of the following corner categories: a short-side left corner, a short-side right corner, a long-side left corner, or a long-side right corner.

Object pose model 120 may determine an estimated center point 210 of a bounding box 206 for object 202 based on the positions of the one or more corners and the one or more corner categories that correspond to the one or more corners. Object pose model 120 may estimate a length and a width of object 202, and may determine the estimated center point 210 of the bounding box 206 for object 202 based on traversing half the length of object 202 from the estimated position of corner 212 towards the center of object 202 and traversing half the width of object 202 from the estimated position of corner 212.

Object pose model 120 may generate the bounding box 206 based on the estimated center point 210 of the bounding box 206. For example, object pose model 120 may generate the bounding box 206 having a center point at the estimated center point 210 and having dimensions that correspond to the estimated length, width, and height of object 202. Object pose model 120 may output an indication of the bounding box 206, which may be coordinates of the position, dimensions, rotation, and the like of the bounding box 206 in the global coordinate space of the scene 250 captured in image 200. A system, such as machine learning model 106, may train an automotive perception model, such as machine learning model 106, to perform object recognition using a training dataset that includes the indication of the bounding box 206. In other examples, an automotive perception model may receive the indication of the bounding box 206 as input during inference time to perform object recognition in scenes captured by camera 220.

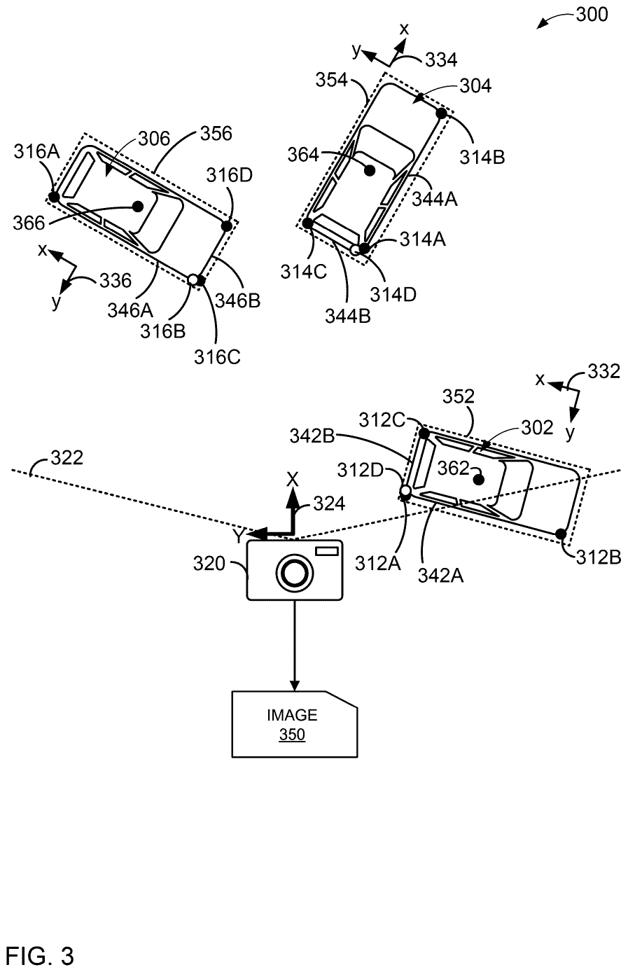

FIG. 3 is a conceptual diagram showing an example technique for generating bounding boxes for objects captured in an image, according to the techniques of this disclosure. For ease, the example is described with respect to FIG. 1.

FIG. 3 shows an example bird's eye view of scene 300 captured in image 350 by camera 320, where scene 300 includes objects 302, 304, and 306 in. In this example, objects 302, 304, and 306 are each a vehicle. While objects 304 and 306 are entirely within camera 320's field of view 322, and therefore entirely within image 350 captured by camera 320, a portion of object 302 is outside of camera 320's field of view 322, and thus, the portion of object 302 outside of camera 320's field of view 322 is not captured in image 350.

Objects 302, 304, and 306 may each have a direction polarity. That is, each of objects 302, 304, and 306 may have a front and a rear, and may also have a left side and a right side that connect the front of the object to the rear of the object. In the example of FIG. 3, objects 302, 304, and 306 may be vehicles, such as cars, trucks, and the like each having a front side and a rear side.

Objects 302, 304, and 306 may each have a plurality of corners. Object 302 includes corners 312A-312D, object 304 may have corners 314A-314D, and object 306 may have corners 316A-316D. While FIG. 3 illustrates a two-dimensional view of objects 302, 304, and 306, objects 302, 304, and 306 may be three-dimensional objects. Thus each of corners 312A-312D, 314A-314D, and 316A-316D of objects 302, 304, and 306 may be an edge of a three-dimensional object, such as a cuboid, where two planes of the three-dimensional object meet.

Processing circuitry 143 may execute object pose model 120 to estimate positions of one or more corners of an object that correspond to one or more corner categories that are invariant to the direction polarity of the object. Object pose model 120 may use any suitable position estimation technique to estimate the positions of corners 312A-312D, 314A-314D, and 316A-316D of objects 302, 304, and 306, respectively, in image 350.

Processing circuitry 143 may estimate the three-dimensional positions of corners 312A-312D, 314A-314D, and 316A-316D of objects 302, 304, and 306, respectively, in global coordinate space 324 of scene 300 captured in image 350. Global coordinate space 324 of scene 300 may be a three-dimensional coordinate space having X, Y, and Z axes that serve as a shared, fixed reference frame for a scene, as captured in an image (e.g., image 350), that remains consistent for the scene across objects and time.

A corner category may be invariant to the direction polarity of an object when the corner category can correspond to a corner without determining the direction polarity of the object. That is, the corner category may correspond to a corner regardless of whether the corner is a front corner or a rear corner of the object, and/or regardless of whether the corner is a left corner or a right corner. The one or more corner categories may be part of a plurality of corner categories that include a short-side left corner, a short-side right corner, a long-side left corner, and a long-side right corner. Given an object having a length l, a width w, and a height h, where width w is less than length l, the object may have two sides each having length l and two sides each having width w. A long side of the object may therefore be a side of the object having length l, and a short side of the object may be a side of the object having width w. The short-side left corner and the short-side right corner of an object may be endpoints of a short side of the object. Out of two endpoints of a short side of the object, the short-side left corner may be the leftmost endpoint of the two endpoints as captured in image 350 and the soft-side right corner may be the rightmost endpoint of the two endpoints as captured in image 350.

Similarly, the long-side left corner and the long-side right corner of an object may be endpoints of a long side of the object. Out of two endpoints of a long side of the object, the long-side left corner may be the leftmost endpoint of the two endpoints as captured in image 350 and the long-side right corner may be the rightmost endpoint of the two endpoints as captured in image 350.

Object pose model 120 may determine, from the portion of an object captured by camera 320 within image 350, a long side of the object and/or a short side of the object out of one or more visible sides of the object in image 350 via any suitable. Object pose model 120 may, based on the determined long side of an object and/or short side of the object that are visible in image 350, one or more corners of the object that correspond to the one or more corner categories and may determine the three-dimensional positions of the determined one or more corners of the object.

In the example of FIG. 3, object pose model 120 may determine object 306 to have long side 346A and short side 346B. Object pose model 120 may determine that corners 316A and 316B are endpoints of long side 346A. Object pose model 120 may determine that corner 316A corresponds to a long-side left corner because corner 316A is an endpoint of long side 346A and is to the left of corner 316B in image 350, and may determine that corner 316B corresponds to a long-side right corner because corner 316B is an endpoint of long side 346A and is to the right of corner 316A in image 350. As such, corner 316A may be referred to as long-side left corner 316A, and corner 316B may be referred to as long-side right corner 316B.

Similarly, object pose model 120 may determine that corners 316C and 316D are endpoints of short side 346B of object 306. Object pose model 120 may determine that corner 316C corresponds to a short-side left corner because corner 316C is an endpoint of short side 346B and is to the left of corner 316D in image 350, and may determine that corner 316D corresponds to a short-side right corner because corner 316D is an endpoint of short side 346B and is to the right of corner 316D in image 350. As such, corner 316C may be referred to as short-side left corner 316C, and corner 316D may be referred to as short-side right corner 316D.

In another example, object pose model 120 may also determine object 304 to have long side 344A and short side 344B. Object pose model 120 may determine that corners 314A and 314B are endpoints of long side 344A. Object pose model 120 may determine that corner 314A corresponds to a long-side left corner because corner 314A is an endpoint of long side 344A and is to the left of corner 314B in image 350, and may determine that corner 314B corresponds to a long-side right corner because corner 314B is an endpoint of long side 344A and is to the right of corner 314A in image 350. As such, corner 314A may be referred to as long-side left corner 314A, and corner 314B may be referred to as long-side right corner 314B.

Similarly, object pose model 120 may determine that corners 314C and 314D are endpoints of short side 344B of object 306. Object pose model 120 may determine that corner 314C corresponds to a short-side left corner because corner 314C is an endpoint of short side 344B and is to the left of corner 314D in image 350, and may determine that corner 314D corresponds to a short-side right corner because corner 314D is an endpoint of short side 344B and is to the right of corner 314D in image 350. As such, corner 314C may be referred to as short-side left corner 314C, and corner 314D may be referred to as short-side right corner 314D.

In another example, object pose model 120 may also determine object 302 to have long side 342A and short side 342B. Object pose model 120 may determine that corners 312A and 312B are endpoints of long side 342A. As can be seen, even though corner 312B is outside of field of view 322 of camera 320 and thus not visible in image 350, object pose model 120 may, in some examples, be able to estimate that an object has a corner that is not visible in image 350.

Object pose model 120 may determine that corner 312A corresponds to a long-side left corner and that corner 312B corresponds to a long-side right corner. As such, corner 312A may be referred to as long-side left corner 312A, and corner 312B may be referred to as long-side right corner 312B. Similarly, object pose model 120 may determine that corners 312C and 312D are endpoints of short side 342B of object 306. Object pose model 120 may determine that corner 312C corresponds to a short-side left corner because corner 312C is an endpoint of short side 342B and is to the left of corner 312D in image 350, and may determine that corner 312D corresponds to a short-side right corner because corner 312D is an endpoint of short side 342B and is to the right of corner 312D in image 350. As such, corner 312C may be referred to as short-side left corner 312C, and corner 312D may be referred to as short-side right corner 312D.

In the example of FIG. 3, object pose model 120 may, for object 306, estimate positions of one or more of long-side left corner 316A, long-side right corner 316B, short-side left corner 316C, and/or short-side right corner 316D. Object pose model 120 may, for object 304, estimate positions of one or more of long-side left corner 314A, long-side right corner 314B, short-side left corner 314C, and/or short-side right corner 314D. Object pose model 120 may, for object 302, estimate positions of one or more of long-side left corner 312A, long-side right corner 312B, short-side left corner 312C, and/or short-side right corner 312D. As can be seen, even though long-side right corner 312B of object 302 is outside the field of view 322 of camera 320 and thus not captured in image 350, object pose model 120 may, in some instances, still estimate the position of long-side right corner 312B of object 302 in global coordinate space 324.

Object pose model 120 may generate a bounding box for an object captured in image 350. The bounding box for an object may be a three-dimension bounding box that bounds the width, length, and height of the object in three-dimensional space (e.g., in global coordinate space 324 of scene 300) to defines the spatial extent of the object within the three-dimensional space. For example, object pose model 120 may generate bounding box 352 that bounds object 302, bounding box 354 that bounds object 304, and bounding box 356 that bounds object 306.

Object pose model 120 may determine a position of an estimated center point of the bounding box based on the estimated positions of one or more corners of the object that correspond to one or more corner categories that are invariant to the direction polarity of the object. For example, object pose model 120 may determine a position of estimated center point 362 of bounding box 352 of object 302, a position of estimated center point 364 of bounding box 354 of object 304, and/or a position of estimated center point 366 of bounding box 356 of object 306.

Each object in scene 300 may be associated with a local coordinate space (x, y, z), and object pose model 120 may determine an estimated position of a center point the bounding box using the local coordinate space of the object. As shown in FIG. 3, object 302 is associated with local coordinate space 332, object 304 is associated with local coordinate space 334, and object 306 is associated with local coordinate space 336.

A local coordinate space of an object may be centered on the object and may be defined relative to the object, such that the local coordinate space for an object may move and rotate to correspond to movement and rotation of the object with respect to the global coordinate space 324 for scene 300. The angle between a local coordinate space and global coordinate space 324 around the z-axis of global coordinate space 324 may be a direction polarity invariant yaw angle, \tilde{φ}.

The directions of the axes of a local coordinate space for an object may be defined in relation to global coordinate space 324 such that the dot product of the x-axis of the local space and the x-axis of global coordinate space 324 is greater than zero, and the dot product of the y-axis of the local space and the y-axis of global coordinate space 324 is greater than zero. Given a local coordinate space of (x, y, z) and global coordinate space 324 of (X, Y, Z), the relationship between the directions of the axes of a local coordinate space and that of global coordinate space 324 may be expressed as x·X>0 and y·Y>0.

Object pose model 120 may determine the estimated center point of the bounding box for an object as being half a length of the long side of the object away from a position of a corner of the object out of the one or more corners of the object in a first direction within the local coordinate space of the object and as being half a width of the short side of the object away from the position of the corner in the second direction perpendicular to the first direction within the local coordinate space of the object. That is, given the long side of an object being along the x-axis of the local coordinate space of the object and the short side of the object being along the y-axis of the local coordinate space, which is perpendicular to the x-axis, object pose model 120 may determine the estimated center point of the bounding box as being positioned half a length of the object away from the position of the corner along the x-axis of the local coordinate system towards the center of the object and half a width of the object away from the position of the corner along the y-axis of the local coordinate system towards the center of the object.

For example, object pose model 120 may determine, from an estimated position of long-side left corner 316A of object 306, the position of an estimated center point 366 of a bounding box 356 for object 306 to be half of the length of the long side 346A of object 306 away from long-side left corner 316A of object 306 along the x-axis of local coordinate space 336 towards long-side right corner 316B of object 306, and half of the width of the short side 346B of object 306 away from long-side left corner 316A of object 306 along the y-axis of local coordinate space 336 towards the center of object 306.

Object pose model 120 may use any suitable technique to select a corner of an object that corresponds to a corner category out of one or more corners of the object that correspond to one or more corner categories that are invariant to the direction polarity of the object, and may determine an estimated center point of a bounding box that bounds the object. In some examples, object pose model 120 may use a heuristic to determine the corner from which object pose model 120 may determine the most accurate estimated center point of the bounding box out of the one or more corners of the object, and may select the corner for use in determining the estimated center point of the bounding box. In some examples, object pose model 120 may select the corner that is nearest to the center of image 350 out of the one or more corners for use in determining the estimated center point of the bounding box.

An object in scene 300 may be associated with a local coordinate space for the object, and object pose model 120 may determine an estimated position of a center point of the bounding box based on the estimated positions of one or more corners of the object in the local coordinate space for the object. The local coordinate space for an object may be centered on the object and may be defined relative to the object, such that the local coordinate space for an object may move and rotate to correspond to movement and rotation of the object with respect to the global coordinate space 324 for scene 300.

In the example of FIG. 3, object 302 is associated with local coordinate space 332, object 304 is associated with local coordinate space 334, and object 306 is associated with local coordinate space 336. Each of local coordinate spaces 332, 334, and 336 is centered on and defined relative to objects 302, 304, and 306, respectively. In each of local coordinate spaces 332, 334, and 336, the x-axis is aligned with a long side of the object (e.g., the length of the object), and the y-axis is aligned with a short side of the object (e.g., the width of the object). As can be seen, object pose model 120 may traverse from a corner of an object to a center point by adding or subtracting half the width of the object to or from the y-axis value of the position of the center in the local coordinate of the object and by adding or subtracting half the length of the object to or from the x-axis value of the position of the center in the local coordinate of the object.

Given local coordinate space 334 for object 304, object pose model 120 may determine the position of an estimated center point 364 of a bounding box 354 for object 304 based on any of long-side left corner 314A, long-side right corner 314B, short-side left corner 314C, or short-side right corner 314D of object 306. If object pose model 120 determine the position of an estimated center point 364 of a bounding box 354 for object 304 based on short-side left corner 314C, object pose model 120 may determine the estimated position of short-side left corner 314C in local coordinate space 334, including determining the x-axis value for the estimated position of short-side left corner 314C in local coordinate space 334 and the y-axis value for the estimated position of short-side left corner 314C in local coordinate space 334.

Object pose model 120 may determine the position of an estimated center point 364 of a bounding box 354 for object 304 to be half of the length of the long side 344A of object 304 from short-side left corner 314C of object 304 in local coordinate space 334 towards the center of object 304 along the x-axis of local coordinate space 334 and half of the width of the short side 344B of object 304 from short-side left corner 314C of object 304 in local coordinate space 334 towards the center of object 304 along the y-axis of local coordinate space 334. As can be seen in FIG. 3, the estimated center point 364 of the bounding box 354 for object 304 will have a y-axis value that is smaller than the y-axis value of the estimated position of short-side left corner 314C in local coordinate space 334, and will have an x-axis value that is larger than the x-axis value of the estimated position of short-side left corner 314C in local coordinate space 334. As such, object pose model may determine the y-axis value in local coordinate space 334 of the position of the estimated center point 364 of the bounding box 354 for object 304 to be the y-axis value of the estimated position of short-side left corner 314C in local coordinate space 334 minus half the width of object 304. Similarly, object pose model may determine the x-axis value in local coordinate space 334 of the position of the estimated center point 364 of bounding box 354 for object 304 to be the x-axis value of the estimated position of short-side left corner 314C in local coordinate space 334 plus half the length of object 304.

In another example, given local coordinate space 332 for object 302, object pose model 120 may determine the position of an estimated center point 362 of a bounding box 352 for object 302 based on any of long-side left corner 312A, long-side right corner 312B, short-side left corner 312C, or short-side right corner 312D of object 306. If object pose model 120 determine the position of an estimated center point 362 of a bounding box 352 for object 302 based on short-side left corner 312C, object pose model 120 may determine the estimated position of short-side left corner 312C in local coordinate space 332, including determining the x-axis value for the estimated position of short-side left corner 312C in local coordinate space 332 and the y-axis value for the estimated position of short-side left corner 312C in local coordinate space 332.

Similar to determining the position of an estimated center point 364 of a bounding box 354 for object 304, object pose model 120 may determine the position of an estimated center point 362 of a bounding box 352 for object 302 to be half of the length of object 302 from short-side left corner 312C of object 302 in local coordinate space 332 towards the center of object 302 along the x-axis of local coordinate space 332 and half of the width of object 302 from short-side left corner 312C of object 302 in local coordinate space 332 towards the center of object 302 along the y-axis of local coordinate space 332. As can be seen in FIG. 3, the estimated center point 362 of the bounding box 352 for object 302 will have a y-axis value that is greater than the y-axis value of the estimated position of short-side left corner 312C in local coordinate space 332, and will have an x-axis value that is smaller than the x-axis value of the estimated position of short-side left corner 312C in local coordinate space 332. As such, object pose model may determine the y-axis value in local coordinate space 332 of the position of the estimated center point 362 of the bounding box 352 for object 302 to be the y-axis value of the estimated position of short-side left corner 312C in local coordinate space 332 plus half the width of object 302. Similarly, object pose model may determine the x-axis value in local coordinate space 332 of the position of the estimated center point 362 of the bounding box 352 for object 302 to be the x-axis value of the estimated position of short-side left corner 312C in local coordinate space 332 minus half the length of object 304.

As can be seen, object pose model 120 may determine whether to add or to subtract half the length of an object to or from the x-axis value of an estimated position of a corner of an object and whether to add or to subtract half the length of the object to or from the y-axis value of the estimated position of a corner of the object to determine an estimated center point of a bounding box for the object. Such a determination may be based on the corner category of the corner of the object used to determine the estimated center position of the bounding box and the orientation of the local coordinate space of the object in relation to global coordinate space 324.

For example, if object pose model 120 determines an estimated center point of a bounding box for an object based on the short-side left corner or the short-side right corner of the object, object pose model 120 may use the orientation of the x axis of the local coordinate system for the object, which may be the axis that aligns with the short side of the object, in relation to global coordinate space 324 to determine whether to add or to subtract half the length of an object to or from the x-axis value of the estimated position of the corner of an object and whether to add or to subtract half the width of the object to or from the y-axis value of the estimated position of the corner of the object to determine the estimated center point of the bounding box. To that end, object pose model 120 may determine a short-side vector for the object that is the position of the short-side left corner of the object in the local coordinate space for the object minus the position of the short-side right corner of the object in the local coordinate space for the object and may determine the estimated center point of the bounding box based on an angle between the short-side vector and a y-axis of global coordinate space 324.

Object pose model 120 may determine whether the short-side vector for an object forms an acute angle or an obtuse angle with they-axis of the global coordinate space 324 to determine whether to add or to subtract half the length of an object to or from the x-axis value of an estimated position of a corner of an object and whether to add or to subtract half the width of the object to or from the y-axis value of the estimated position of a corner of the object to determine an estimated center point of a bounding box for the object.

Formally, adding or subtracting half the length of an object to or from the x-axis value of an estimated position of a corner of an object and adding or subtracting half the width of the object to or from the y-axis value of the estimated position of a corner of the object to determine an estimated center point of a bounding box for the object can be represented as

$$( \begin{matrix}\pm \frac{length}{2} \\ \pm \frac{width}{2}\end{matrix} ) .$$

Adding half the length of an object to the x-axis value of an estimated position of a corner of an object and adding half the width of the object to the y-axis value of the estimated position of a corner of the object to determine an estimated center point of a bounding box for the object can be represented as

$$( \begin{matrix}+ \frac{length}{2} \\ + \frac{width}{2}\end{matrix} ) or ( \begin{matrix}+ \\ +\end{matrix} ) .$$

Adding half the length of an object to the x-axis value of an estimated position of a corner of an object and subtracting half the width of the object from the y-axis value of the estimated position of a corner of the object to determine an estimated center point of a bounding box for the object can be represented as

$$( \begin{matrix}+ \frac{length}{2} \\ - \frac{width}{2}\end{matrix} ) or ( \begin{matrix}+ \\ -\end{matrix} ) .$$

Subtracting half the length of an object from the x-axis value of an estimated position of a corner of an object and adding half the width of the object to the y-axis value of the estimated position of a corner of the object to determine an estimated center point of a bounding box for the object can be represented as

$$( \begin{matrix}- \frac{length}{2} \\ + \frac{width}{2}\end{matrix} ) or ( \begin{matrix}- \\ +\end{matrix} ) .$$

Subtracting half the length of an object from the x-axis value of an estimated position of a corner of an object and subtracting half the width of the object from the y-axis value of the estimated position of a corner of the object to determine an estimated center point of a bounding box for the object can be represented as

$$( \begin{matrix}- \frac{length}{2} \\ - \frac{width}{2}\end{matrix} ) or ( \begin{matrix}- \\ -\end{matrix} ) .$$

A short-side vector for an object can be represented as S̅=S̅_{L}−S̅_{R}, where S̅_{L} is the estimated three-dimensional position for a short-left corner of the object in the object's local coordinate space and S̅_{R} is the estimated position for a short-right corner of the object in the local coordinate space. Object pose model 120 may perform a dot product of short-side vector S̅ with a rotation matrix T multiplied by a unit vector along the y-axis of the local coordinate space for the object, where T is a rotation matrix for rotating from a local coordinate space of the object to global coordinate space 324, which can be represented as

$$\overline{s} \cdot T ( \begin{matrix}0 \\ 1 \\ 0\end{matrix} ) .$$

Object pose model 120 may, based on determining the short-side vector s for an object, determine an estimated position of a center point of a bounding box for the object based on the estimated position of a short-side right corner of the object or the estimated position of a short-side left corner of the object. Object pose model 120 may determine whether the resulting value of

$$\overline{s} \cdot T ( \begin{matrix}0 \\ 1 \\ 0\end{matrix} )$$

is less than zero, expressed as

$$\overline{s} \cdot T ( \begin{matrix}0 \\ 1 \\ 0\end{matrix} ) < 0 ,$$

which may indicate that the short-side vector s forms an obtuse angle with the Y-axis of the global coordinate space 324, or greater than zero, expressed as

$$\overline{s} \cdot T ( \begin{matrix}0 \\ 1 \\ 0\end{matrix} ) > 0 ,$$

which may indicate that the short-side vector s forms an acute with the Y-axis of the global coordinate space 324.

If object pose model 120 determines that

$$\overline{s} \cdot T ( \begin{matrix}0 \\ 1 \\ 0\end{matrix} ) < 0 ,$$

object pose model 120 may be able to determine an x-axis value of an estimated center point of a bounding box for an object in the local coordinate space by subtracting half the length of the object from the x-axis value of the estimated position of the short-left corner of the object in the local coordinate space and to determine a y-axis value of the estimated center point of the bounding box in the local coordinate space by adding half the width of the object to the y-axis value of the estimated position of the short-left corner of the object in the local coordinate space, expressed as

$$( \begin{matrix}- \frac{length}{2} \\ + \frac{width}{2}\end{matrix} ) or ( \begin{matrix}- \\ +\end{matrix} ) .$$

Similarly, if object pose model 120 determines that

$$\overline{s} \cdot T ( \begin{matrix}0 \\ 1 \\ 0\end{matrix} ) < 0 ,$$

object pose model 120 may be able to determine an x-axis value of an estimated center point of a bounding box for an object in the local coordinate space by subtracting half the length of the object from the x-axis value of an estimated position of the short-right corner in local coordinate space. Object pose model 120 may also be able to determine a y-axis value of the estimated center point of the bounding box in local coordinate space by subtracting half the width of the object from the y-axis value of the estimated position of the short-right corner of the object in local coordinate space to determine a y-axis value of the estimated center point of the bounding box in local coordinate space, expressed as

$$( \begin{matrix}- \frac{length}{2} \\ - \frac{width}{2}\end{matrix} ) or ( \begin{matrix}- \\ -\end{matrix} ) .$$

If object pose model 120 determines that

$$\overline{s} \cdot T ( \begin{matrix}0 \\ 1 \\ 0\end{matrix} ) > 0 ,$$

object pose model 120 may be able to determine an x-axis value of an estimated center point of a bounding box for an object in local coordinate space for the object by adding half the length of the object to the x-axis value of the estimated position of the short-left corner of the object in local coordinate space. Object pose model 120 may also be able to determine a y-axis value of the estimated center point of the bounding box in local coordinate space by subtracting half the width of the object from the y-axis value of the estimated position of the short-left corner of the object in local coordinate space, expressed as

$$( \begin{matrix}+ \frac{length}{2} \\ - \frac{width}{2}\end{matrix} ) or ( \begin{matrix}+ \\ -\end{matrix} ) .$$

Similarly, if object pose model 120 determines that

$$\overline{s} \cdot T ( \begin{matrix}0 \\ 1 \\ 0\end{matrix} ) > 0 ,$$

object pose model 120 may be able to determine an x-axis value of an estimated center point of a bounding box for an object in local coordinate space by adding half the length of the object to the x-axis value of an estimated position of the short-right corner in local coordinate space. Object pose model 120 may also be able to determine a y-axis value of the estimated center point of the bounding box in local coordinate space by adding half the width of the object to the y-axis value of the estimated position of the short-right corner of the object in local coordinate space to determine a y-axis value of the estimated center point of the bounding box in local coordinate space, expressed as

$$( \begin{matrix}+ \frac{length}{2} \\ + \frac{width}{2}\end{matrix} ) or ( \begin{matrix}+ \\ +\end{matrix} ) .$$

In some examples, if object pose model 120 determines an estimated center point of a bounding box for an object based on the long-side left corner or the long-side right corner of the object, object pose model 120 may use the orientation of the x axis of the local coordinate system for the object, which may be the axis that aligns with the long side of the object, in relation to global coordinate space 324 to determine whether to add or to subtract half the length of an object to or from the x-axis value of the estimated position of the corner of an object and whether to add or to subtract half the width of the object to or from the y-axis value of the estimated position of the corner of the object to determine the estimated center point of the bounding box. To that end, object pose model 120 may determine a long-side vector for the object that is the position of the long-side left corner of the object in the local coordinate space for the object minus the position of the long-side right corner of the object in the local coordinate space for the object and may determine the estimated center point of the bounding box based on an angle between the long-side vector and a x-axis of global coordinate space 324.

Object pose model 120 may determine whether the long-side vector for an object forms an acute angle or an obtuse angle with the x-axis of the global coordinate space 324 to determine whether to add or to subtract half the length of an object to or from the x-axis value of an estimated position of a corner of an object and whether to add or to subtract half the width of the object to or from the y-axis value of the estimated position of a corner of the object to determine an estimated center point of a bounding box for the object. A long-side vector for an object can be represented as l̅=l̅_{L}−l̅_{R}, where l̅_{L} is the estimated position for a long-left corner of the object in local coordinate space and IR is the estimated position for a long-right corner of the object in local coordinate space. Object pose model 120 may perform a dot product of long-side vector l̅ with a rotation matrix T multiplied by a unit vector along the x-axis of the local coordinate space for the object, where T is a rotation matrix for rotating from a local coordinate space of the object to global coordinate space 324, which can be represented as

$$\overline{l} \cdot T ( \begin{matrix}1 \\ 0 \\ 0\end{matrix} ) .$$

Object pose model 120 may, based on determining the long-side vector l̅ for an object, determine an estimated position of a center point of a bounding box for the object based on the estimated position of a long-side right corner of the object or the estimated position of a long-side left corner of the object. Object pose model 120 may determine whether the resulting value of

$$\overline{l} \cdot T ( \begin{matrix}1 \\ 0 \\ 0\end{matrix} )$$

is less than zero, expressed as

$$\overline{l} \cdot T ( \begin{matrix}1 \\ 0 \\ 0\end{matrix} ) < 0 ,$$

which may indicate that the long-side vector l̅ forms an obtuse angle with the x-axis of the global coordinate space 324, or greater than zero, expressed as

$$T ( \begin{matrix}1 \\ 0 \\ 0\end{matrix} ) > 0 ,$$

which may indicate that the long-side vector l̅ forms an acute with the x-axis of the global coordinate space 324.

If object pose model 120 determines that

$$\overline{l} \cdot T ( \begin{matrix}1 \\ 0 \\ 0\end{matrix} ) < 0 ,$$

object pose model 120 may be able to determine an x-axis value of an estimated center point of a bounding box for an object in local coordinate space by adding half the length of the object to the x-axis value of the estimated position of a long-left corner of the object in local coordinate space. Object pose model 120 may also be able to determine a y-axis value of the estimated center point of the bounding box in local coordinate space by adding half the width of the object to the y-axis value of the estimated position of the long-left corner of the object in local coordinate space, expressed as

$$( \begin{matrix}+ \frac{length}{2} \\ + \frac{width}{2}\end{matrix} ) or ( \begin{matrix}+ \\ +\end{matrix} ) .$$

Similarly, if object pose model 120 determines that

$$\overline{l} \cdot T ( \begin{matrix}1 \\ 0 \\ 0\end{matrix} ) < 0 ,$$

object pose model 120 may be able to determine an x-axis value of an estimated center point of a bounding box for an object in local coordinate space by subtracting half the length of the object from the x-axis value of an estimated position of the long-right corner in local coordinate space. Object pose model 120 may also be able to determine a y-axis value of the estimated center point of the bounding box by adding half the width of the object to the y-axis value of the estimated position of the long-right corner of the object in local coordinate space to determine a y-axis value of the estimated center point of the bounding box in local coordinate space, expressed as

$$( \begin{matrix}- \frac{length}{2} \\ + \frac{width}{2}\end{matrix} ) or ( \begin{matrix}- \\ +\end{matrix} ) .$$

If object pose model 120 determines that

$$\overline{l} \cdot T ( \begin{matrix}1 \\ 0 \\ 0\end{matrix} ) > 0 ,$$

object pose model 120 may be able to determine an x-axis value of an estimated center point of a bounding box for an object in local coordinate space by subtracting half the length of the object from the x-axis value of the estimated position of a long-left corner of the object in local coordinate space. Object pose model 120 may also be able to determine a y-axis value of the estimated center point of the bounding box in local coordinate space by subtracting half the width of the object from the y-axis value of the estimated position of the long-left corner of the object in local coordinate space, expressed as

$$( \begin{matrix}- \frac{length}{2} \\ - \frac{width}{2}\end{matrix} ) or ( \begin{matrix}- \\ -\end{matrix} ) .$$

Similarly, if object pose model 120 determines that

$$\overline{l} \cdot T ( \begin{matrix}1 \\ 0 \\ 0\end{matrix} ) > 0 ,$$

object pose model 120 may be able to determine an x-axis value of an estimated center point of a bounding box for an object in local coordinate space by adding half the length of the object to the x-axis value of an estimated position of the long-right corner in local coordinate space. Object pose model 120 may also be able to determine a y-axis value of the estimated center point of the bounding box in local coordinate space by subtracting half the width of the object from the y-axis value of the estimated position of the long-right corner of the object in local coordinate space to determine a y-axis value of the estimated center point of the bounding box in local coordinate space, expressed as

$$( \begin{matrix}+ \frac{length}{2} \\ - \frac{width}{2}\end{matrix} ) or ( \begin{matrix}+ \\ -\end{matrix} ) .$$

Object pose model 120 may therefore be able to determine, for an object, an estimated center point of a bounding box for the object based on the estimated position of a single corner of the object. In some of the examples above, object pose model 120 may determine, for an object an estimated center point of a bounding box for the object in the local coordinate space of the object. In these examples, object pose model 120 may perform any suitable techniques to transform the estimated center point of a bounding box for an object in the local coordinate space of the object to a corresponding estimated center point of the bounding box for the object in global coordinate space 324.

In some examples, object pose model 120 may be able to determine, for an object, multiple estimated center points of a bounding box for the object based on estimated positions of multiple corners of the object, and determine an estimated center point of the bounding box based on the multiple estimated center points of the bounding box. For example, object pose model 120 may determine, for a bounding box of an object, a first estimated center point of the bounding box based on the estimated position of a short-left corner of the object, and may determine a second estimated center point of the bounding box based on the estimated position of a long-left corner of the object, such as by performing techniques described in this disclosure. Object pose model 120 may be able to determine an estimated center point of the bounding box based on the first estimated center point and the second estimated center point.

In some examples, object pose model 120 may determine an estimated center point of a bounding box as the weighted average (e.g., weighted mean) of multiple estimated center points of the bounding box. For example, given a first estimated center point cp₁ for the bounding box and a second estimated center point cp₂ for the bounding box, object pose model 120 may determine the estimated center point of the bounding box as w₁cp₁+w₂cp₂, where w₁ and w₂ are weights, and where w₁+w₂=1. Object pose model 120 may determine the weights for weighing the multiple estimated center points of the bounding box via any suitable technique, such as weighing each of the estimated center points based on a confidence of the estimated positions of the corners of the object used to determine the estimated center points of the bounding box.

Object pose model 120 may generate a bounding box that bounds an object based on the estimated center point of the bounding box using any suitable bounding box generation technique technique. As described above, the bounding box for an object may be a two-dimensional or three-dimensional bounding box for the object, such as a rectangular cuboid that bounds the object. Given the estimated center point of the bounding box as well as the previously determined length and width of the object to be bound by the bounding box, object pose model 120 may generate a bounding box for an object centered at the estimated center point of the bounding box and having a length and width that correspond to the length and width of the object bound by the bounding box.

In some examples, object pose model 120 may determine the absolute direction of an object, such as by determining which side (e.g., front, rear, left, or right) of the object is facing camera 320 in image 350, and may generate a bounding box that bounds the object based on the absolute direction of the object. In some examples, object pose model 120 may utilize a classifier that can be parameterized as a multi-class problem with binary variables of front, rear, left, and right to determine the absolute direction of the object. Object pose model 120 may use such a classifier to determine the yaw angle φ of the object based on the direction polarity invariant yaw angle, \tilde{φ} of the object, and may generate a bounding box that bounds the object based on the yaw angle φ of the object.

In some examples, object pose model 120 may also generate the bounding box based on the estimated positions of one or more corners of the object bound by the bounding box in global coordinate space 324. As described above, object pose model 120 may estimate the position of a corner of an object, and may use the estimated position of the corner of the object to determine the estimated center point of the bounding box. Because object pose model 120 has already estimated the position of the corner of the object, object pose model 120 may anchor a corresponding corner of the bounding box to the estimated position of the corner of the object. That is, object pose model 120 may set the estimated position of a corner of the object in global coordinate space 324 as the position of a corresponding corner of the bounding box that bounds the object. For example, if object pose model 120 has determined an estimated position of short-side left corner 316C of object 306 in global coordinate space 324, object pose model 120 may set the estimated position of short-side left corner 316C of object 306 as the position of a corner of a bounding box that bounds object 306.

Object pose model 120 may output an indication of the generated bounding box for an object. The indication of the bounding box in scene 300 may be indications of the position, dimensions, rotation, and the like of the bounding box in global coordinate space 324 in scene 300. For example, the indication of a bounding box may include three-dimensional positions of corners of the bounding box, dimensions (e.g., width, length, and/or height) of the bounding box, the orientation (e.g., yaw, roll, and/or pitch) of bounding box in global coordinate space 324, and the like.

Object pose model 120 may anchor the bounding box for an object at the estimated positions of the one or more corners of the object in global coordinate space 324. That is, object pose model 120 may set one or more corners of the bounding box to be in the same positions in the global coordinate space as the estimated positions of the one or more corners of the object that the bounding box bounds.

In some examples, machine learning system 104 may train an automotive perception model, such as machine learning model 106, using a training dataset that includes the indication of the bounding box. For example, machine learning system 104 may include, in a training dataset, an image, such as image 350, that captures a scene, such as scene 300 that includes one or more objects, such as object 302, along with an indication of a bounding box for the object. Machine learning system 104 may use such a training dataset, to train the automotive perception model to perform object detection of objects in scenes in images (e.g., captured by a camera).

In some examples, an automotive perception model, such as machine learning model 106, may use the techniques of this disclosure during inference time to perform object detection of objects in scenes in images (e.g., captured by a camera). During inference time, a system that includes an automotive perception model, such as an advanced driver assistance system (ADAS) may input images captured by a camera of scenes containing objects along with indications of bounding boxes for the objects in the scene into the automotive perception model, and the automotive perception model may use the indications of bounding boxes for the objects in the scene to detect objects in the scene.

In some examples, a vehicle system, such as an ADAS, may display a representation of bounding boxes that bound objects recognized by an automotive perception model. For example, the vehicle system may display a navigational map that presents bounding boxes to represent objects that are detected by the automotive perception model in the environment surrounding the vehicle.

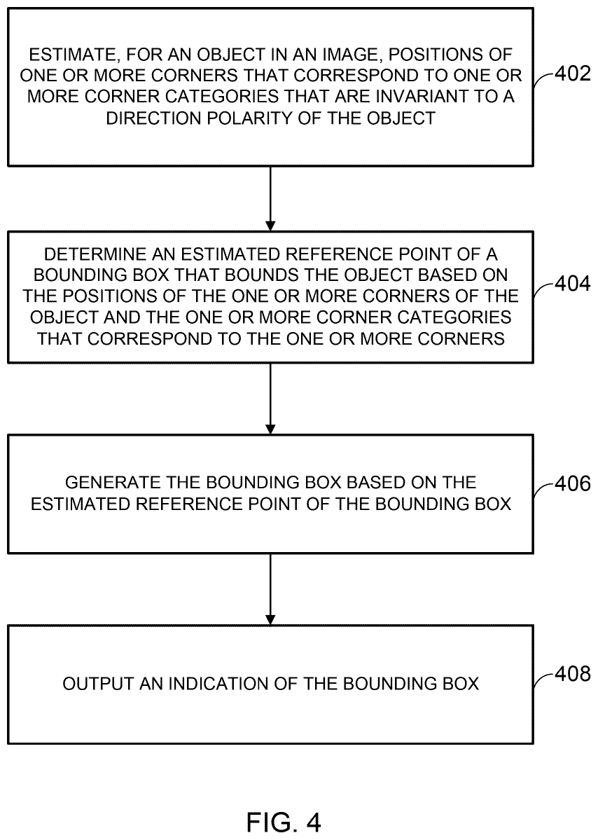

FIG. 4 is a flowchart showing an example method of operation according to the techniques of this disclosure. For ease, the example is described with respect to FIG. 1.

As shown in FIG. 4, processing circuitry 143 may estimate, for an object in an image, positions of one or more corners that correspond to one or more corner categories that are invariant to a direction polarity of the object (402). In some examples, the one or more corner categories include one or more of: a short-side left corner, a short-side right corner, a long-side left corner, or a long-side right corner, wherein the short-side left corner and the short-side right corner are estimated endpoints of a short side of the object visible in the image, and wherein the long-side left corner and the long-side right corner are estimated endpoints of a long side of the object visible in the image. In some examples, the positions of the one or more corners are three-dimensional positions within a global coordinate space of a scene captured in the image.

Processing circuitry 143 may determine an estimated reference point of a bounding box that bounds the object based on the positions of the one or more corners of the object and the one or more corner categories that correspond to the one or more corners (404). In some examples, the estimated reference point of the bounding box is an estimated center point of the bounding box. In some examples, to determine the estimated reference point of the bounding box, processing circuitry 143 may determine the estimated reference point of the bounding box as being half a length of the long side of the object away from a position of a corner of the object out of the one or more corners of the object in a first direction within a local coordinate space of the object and as being half a width of the short side of the object away from the position of the corner in a second direction perpendicular to the first direction within the local coordinate space of the object.

In some examples, the corner of the object is the short-side right corner of the object or the short-side left corner of the object, and to determine the estimated reference point of the bounding box, processing circuitry 143 may determine a short-side vector as a position of the short-side left corner of the object in the local coordinate space of the object minus a position of the short-side right corner of the object in the local coordinate space of the object and may determine the estimated reference point of the bounding box based on an angle between the short-side vector and a y-axis of a global coordinate space of a scene captured in the image.

In some examples, the corner of the object is the long-side right corner of the object or the long-side left corner of the object, and to determine the estimated reference point of the bounding box, processing circuitry 143 may determine a long-side vector as a position of the long-side left corner of the object in the local coordinate space of the object minus a position of the long-side right corner of the object in the local coordinate space of the object and may determine the estimated reference point of the bounding box based on an angle between the long-side vector and a x-axis of a global coordinate space of a scene captured in the image.

In some examples, the one or more corners include a first corner that corresponds to a first corner category that is invariant to the direction polarity of the object and a second corner that corresponds to a second corner category that is invariant to the direction polarity of the object. To determine the estimated reference point of the bounding box, processing circuitry may determine a first estimated reference point for the bounding box based on a position of the first corner, determine a second estimated reference point for the bounding box based on a position of the second corner, and determine the estimated reference point of the bounding box based on a weighted mean of at least the first estimated reference point and the second estimated reference point.

Processing circuitry 143 may generate the bounding box based on the estimated reference point of the bounding box (406). In some examples, to generate the bounding box, processing circuitry 143 may anchor the bounding box to the positions of the one or more corners of the object.

Processing circuitry 143 may output an indication of the bounding box (408). In some examples, processing circuitry 143 may input the indication of the bounding box into an automotive perception model 106 during inference time to perform one or more object recognition tasks based on the bounding box for the object.

The following describes other example aspects of the disclosure. The techniques of the following aspects may be used separately or in any combination.

Clause 1. A method comprising: estimating, for an object in an image, positions of one or more corners that correspond to one or more corner categories that are invariant to a direction polarity of the object; determining an estimated reference point of a bounding box that bounds the object based on the positions of the one or more corners of the object and the one or more corner categories that correspond to the one or more corners; generating the bounding box based on the estimated reference point of the bounding box; and outputting an indication of the bounding box.

Clause 2. The method of clause 1, wherein the one or more corner categories include one or more of: a short-side left corner, a short-side right corner, a long-side left corner, or a long-side right corner, wherein the short-side left corner and the short-side right corner are estimated endpoints of a short side of the object visible in the image, and wherein the long-side left corner and the long-side right corner are estimated endpoints of a long side of the object visible in the image.

Clause 3. The method of clause 2, wherein determining the estimated reference point of the bounding box further comprises: determining the estimated reference point of the bounding box as being half a length of the long side of the object away from a position of a corner of the object out of the one or more corners of the object in a first direction within a local coordinate space of the object and as being half a width of the short side of the object away from the position of the corner in a second direction perpendicular to the first direction within the local coordinate space of the object.

Clause 4. The method of clause 3, wherein the corner of the object is the short-side right corner of the object or the short-side left corner of the object, and wherein determining the estimated reference point of the bounding box further comprises: determining a short-side vector as a position of the short-side left corner of the object in the local coordinate space of the object minus a position of the short-side right corner of the object in the local coordinate space of the object; and determining the estimated reference point of the bounding box based on an angle between the short-side vector and a y-axis of a global coordinate space of a scene captured in the image.

Clause 5. The method of clause 3, wherein the corner of the object is the long-side right corner of the object or the long-side left corner of the object, and wherein determining the estimated reference point of the bounding box further comprises: determining a long-side vector as a position of the long-side left corner of the object in the local coordinate space of the object minus a position of the long-side right corner of the object in the local coordinate space of the object; and determining the estimated reference point of the bounding box based on an angle between the long-side vector and a x-axis of a global coordinate space of a scene captured in the image.

Clause 6. The method of any of clauses 1-5, wherein the positions of the one or more corners are three-dimensional positions within a global coordinate space of a scene captured in the image.

Clause 7. The method of any of clauses 1-6, wherein generating the bounding box further comprises: anchoring the bounding box to the positions of the one or more corners of the object.

Clause 8. The method any of clauses 1-7, wherein the one or more corners include a first corner that corresponds to a first corner category that is invariant to the direction polarity of the object and a second corner that corresponds to a second corner category that is invariant to the direction polarity of the object, and wherein determining the estimated reference point of the bounding box further comprises: determining a first estimated reference point for the bounding box based on a position of the first corner; determining a second estimated reference point for the bounding box based on a position of the second corner; and determining the estimated reference point of the bounding box based on a weighted mean of at least the first estimated reference point and the second estimated reference point.

Clause 9. The method of any of clauses 1-8, wherein the estimated reference point of the bounding box is an estimated center point of the bounding box.

Clause 10. The method of any of clauses 1-9, wherein outputting the indication of the bounding box further comprises: inputting the indication of the bounding box into an automotive perception model during inference time to perform one or more object recognition tasks based on the bounding box for the object.

Clause 11. A computing system comprising: one or more memories; and processing circuitry implemented in circuitry, coupled to the one or more memories, and configured to: estimate, for an object in an image, positions of one or more corners that correspond to one or more corner categories that are invariant to a direction polarity of the object; determine an estimated reference point of a bounding box that bounds the object based on the positions of the one or more corners of the object and the one or more corner categories that correspond to the one or more corners; generate the bounding box based on the estimated reference point of the bounding box; and output an indication of the bounding box.

Clause 12. The computing system of clause 11, wherein the one or more corner categories include one or more of: a short-side left corner, a short-side right corner, a long-side left corner, or a long-side right corner, wherein the short-side left corner and the short-side right corner are estimated endpoints of a short side of the object visible in the image, and wherein the long-side left corner and the long-side right corner are estimated endpoints of a long side of the object visible in the image.

Clause 13. The computing system of clause 12, wherein to determine the estimated reference point of the bounding box, the processing circuitry is further configured to: determine the estimated reference point of the bounding box as being half a length of the long side of the object away from a position of a corner of the object out of the one or more corners of the object in a first direction within a local coordinate space of the object and as being half a width of the short side of the object away from the position of the corner in a second direction perpendicular to the first direction within the local coordinate space of the object.

Clause 14. The computing system of clause 13, wherein the corner of the object is the short-side right corner of the object or the short-side left corner of the object, wherein to determine the estimated reference point of the bounding box, the processing circuitry is further configured to: determine a short-side vector as a position of the short-side left corner of the object in the local coordinate space of the object minus a position of the short-side right corner of the object in the local coordinate space of the object; and determine the estimated reference point of the bounding box based on an angle between the short-side vector and a y-axis of a global coordinate space of a scene captured in the image.

Clause 15. The computing system of clause 13, wherein the corner of the object is the long-side right corner of the object or the long-side left corner of the object, and wherein to determine the estimated reference point of the bounding box, the processing circuitry is further configured to: determine a long-side vector as a position of the long-side left corner of the object in the local coordinate space of the object minus a position of the long-side right corner of the object in the local coordinate space of the object; and determine the estimated reference point of the bounding box based on an angle between the long-side vector and a x-axis of a global coordinate space of a scene captured in the image.

Clause 16. The computing system of any of clause 11-15, wherein to generate the bounding box, the processing circuitry is further configured to: anchor the bounding box to the positions of the one or more corners of the object.

Clause 17. The computing system of any of clause 11-16, wherein the one or more corners include a first corner that corresponds to a first corner category that is invariant to the direction polarity of the object and a second corner that corresponds to a second corner category that is invariant to the direction polarity of the object, and wherein to determine the estimated reference point of the bounding box, the processing circuitry is further configured to: determine a first estimated reference point for the bounding box based on a position of the first corner; determine a second estimated reference point for the bounding box based on a position of the second corner; and determine the estimated reference point of the bounding box based on a weighted mean of at least the first estimated reference point and the second estimated reference point.

Clause 18. The computing system of any of clause 11-17, wherein the estimated reference point of the bounding box is an estimated center point of the bounding box.

Clause 19. The computing system of any of clause 11-18, wherein to output the indication of the bounding box, the processing circuitry is further configured to: input the indication of the bounding box into an automotive perception model during inference time to perform one or more object recognition tasks based on the bounding box for the object.

Clause 20. A computer-readable storage medium storing instructions thereon that when executed cause processing circuitry to: estimate, for an object in an image, positions of one or more corners that correspond to one or more corner categories that are invariant to a direction polarity of the object; determine an estimated reference point of a bounding box that bounds the object based on the positions of the one or more corners of the object and the one or more corner categories that correspond to the one or more corners; generate the bounding box based on the estimated reference point of the bounding box; and output an indication of the bounding box.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
estimating, for an object in an image, positions of one or more corners that correspond to one or more corner categories that are invariant to a direction polarity of the object;
determining an estimated reference point of a bounding box that bounds the object based on the positions of the one or more corners of the object and the one or more corner categories that correspond to the one or more corners;
generating the bounding box based on the estimated reference point of the bounding box; and
outputting an indication of the bounding box.

2. The method of claim 1, wherein the one or more corner categories include one or more of: a short-side left corner, a short-side right corner, a long-side left corner, or a long-side right corner, wherein the short-side left corner and the short-side right corner are estimated endpoints of a short side of the object visible in the image, and wherein the long-side left corner and the long-side right corner are estimated endpoints of a long side of the object visible in the image.

3. The method of claim 2, wherein determining the estimated reference point of the bounding box further comprises:
determining the estimated reference point of the bounding box as being half a length of the long side of the object away from a position of a corner of the object out of the one or more corners of the object in a first direction within a local coordinate space of the object and as being half a width of the short side of the object away from the position of the corner in a second direction perpendicular to the first direction within the local coordinate space of the object.

4. The method of claim 3, wherein the corner of the object is the short-side right corner of the object or the short-side left corner of the object, and wherein determining the estimated reference point of the bounding box further comprises:
determining a short-side vector as a position of the short-side left corner of the object in the local coordinate space of the object minus a position of the short-side right corner of the object in the local coordinate space of the object; and
determining the estimated reference point of the bounding box based on an angle between the short-side vector and a y-axis of a global coordinate space of a scene captured in the image.

5. The method of claim 3, wherein the corner of the object is the long-side right corner of the object or the long-side left corner of the object, and wherein determining the estimated reference point of the bounding box further comprises:
determining a long-side vector as a position of the long-side left corner of the object in the local coordinate space of the object minus a position of the long-side right corner of the object in the local coordinate space of the object; and
determining the estimated reference point of the bounding box based on an angle between the long-side vector and a x-axis of a global coordinate space of a scene captured in the image.

6. The method of claim 1, wherein the positions of the one or more corners are three-dimensional positions within a global coordinate space of a scene captured in the image.

7. The method of claim 1, wherein generating the bounding box further comprises:
anchoring the bounding box to the positions of the one or more corners of the object.

8. The method of claim 1, wherein the one or more corners include a first corner that corresponds to a first corner category that is invariant to the direction polarity of the object and a second corner that corresponds to a second corner category that is invariant to the direction polarity of the object, and wherein determining the estimated reference point of the bounding box further comprises:
determining a first estimated reference point for the bounding box based on a position of the first corner;
determining a second estimated reference point for the bounding box based on a position of the second corner; and
determining the estimated reference point of the bounding box based on a weighted mean of at least the first estimated reference point and the second estimated reference point.

9. The method of claim 1, wherein the estimated reference point of the bounding box is an estimated center point of the bounding box.

10. The method of claim 1, wherein outputting the indication of the bounding box further comprises:
inputting the indication of the bounding box into an automotive perception model during inference time to perform one or more object recognition tasks based on the bounding box for the object.

11. A computing system comprising:
one or more memories; and
processing circuitry implemented in circuitry, coupled to the one or more memories, and configured to:
estimate, for an object in an image, positions of one or more corners that correspond to one or more corner categories that are invariant to a direction polarity of the object;
determine an estimated reference point of a bounding box that bounds the object based on the positions of the one or more corners of the object and the one or more corner categories that correspond to the one or more corners;
generate the bounding box based on the estimated reference point of the bounding box; and
output an indication of the bounding box.

12. The computing system of claim 11, wherein the one or more corner categories include one or more of: a short-side left corner, a short-side right corner, a long-side left corner, or a long-side right corner, wherein the short-side left corner and the short-side right corner are estimated endpoints of a short side of the object visible in the image, and wherein the long-side left corner and the long-side right corner are estimated endpoints of a long side of the object visible in the image.

13. The computing system of claim 12, wherein to determine the estimated reference point of the bounding box, the processing circuitry is further configured to:
determine the estimated reference point of the bounding box as being half a length of the long side of the object away from a position of a corner of the object out of the one or more corners of the object in a first direction within a local coordinate space of the object and as being half a width of the short side of the object away from the position of the corner in a second direction perpendicular to the first direction within the local coordinate space of the object.

14. The computing system of claim 13, wherein the corner of the object is the short-side right corner of the object or the short-side left corner of the object, wherein to determine the estimated reference point of the bounding box, the processing circuitry is further configured to:
determine a short-side vector as a position of the short-side left corner of the object in the local coordinate space of the object minus a position of the short-side right corner of the object in the local coordinate space of the object; and
determine the estimated reference point of the bounding box based on an angle between the short-side vector and a y-axis of a global coordinate space of a scene captured in the image.

15. The computing system of claim 13, wherein the corner of the object is the long-side right corner of the object or the long-side left corner of the object, and wherein to determine the estimated reference point of the bounding box, the processing circuitry is further configured to:
determine a long-side vector as a position of the long-side left corner of the object in the local coordinate space of the object minus a position of the long-side right corner of the object in the local coordinate space of the object; and
determine the estimated reference point of the bounding box based on an angle between the long-side vector and a x-axis of a global coordinate space of a scene captured in the image.

16. The computing system of claim 11, wherein to generate the bounding box, the processing circuitry is further configured to:
anchor the bounding box to the positions of the one or more corners of the object.

17. The computing system of claim 11, wherein the one or more corners include a first corner that corresponds to a first corner category that is invariant to the direction polarity of the object and a second corner that corresponds to a second corner category that is invariant to the direction polarity of the object, and wherein to determine the estimated reference point of the bounding box, the processing circuitry is further configured to:
determine a first estimated reference point for the bounding box based on a position of the first corner;
determine a second estimated reference point for the bounding box based on a position of the second corner; and
determine the estimated reference point of the bounding box based on a weighted mean of at least the first estimated reference point and the second estimated reference point.

18. The computing system of claim 11, wherein the estimated reference point of the bounding box is an estimated center point of the bounding box.

19. The computing system of claim 11, wherein to output the indication of the bounding box, the processing circuitry is further configured to:
input the indication of the bounding box into an automotive perception model during inference time to perform one or more object recognition tasks based on the bounding box for the object.

20. A computer-readable storage medium storing instructions thereon that when executed cause processing circuitry to:
estimate, for an object in an image, positions of one or more corners that correspond to one or more corner categories that are invariant to a direction polarity of the object;
determine an estimated reference point of a bounding box that bounds the object based on the positions of the one or more corners of the object and the one or more corner categories that correspond to the one or more corners;
generate the bounding box based on the estimated reference point of the bounding box; and
output an indication of the bounding box.
